(19) United States
(12) Patent Application Publication
(10) Pub. No.: US 2011/0259880 A1
(43) Pub. Date: Oct. 27, 2011

(54) MECHANICAL SCRAPER SYSTEM WITH SYNCHRONIZED PULSE ELECTROTHERMAL DEICING

(75) Inventors: Victor F. Petrenko, Lebanon, NH (US); Charles Sullivan, West Lebanon, NH (US)

(73) Assignee: ICECODE, LLC, West Lebanon, NH (US)

(21) Appl. No.: 12/961,797

(22) Filed: Dec. 7, 2010

Related U.S. Application Data
(60) Provisional application No. 61/267,406, filed on Dec. 7, 2009.

(51) Int. Cl. H05B 6/04; H05B 1/00

(52) U.S. Cl. 219/660; 219/201; 219/203

(57) ABSTRACT

A mechanical scraper with synchronized pulse electrothermal deicing includes a heating element that is coupled to a power supply and that is operable to convert power from the power supply into heating energy. A controller controls the magnitude and duration in which power is applied to the heating element, such that only an interfacial layer of ice at an ice-object interface is disrupted for a sufficient period of time to allow the scraper to move or remove the dislodged ice/snow. A scraper then works over the surface to be deiced, thus removing the ice before the interfacial layer re-freezes. Another method of the present invention electromagnetically induces current at the ice-to-object interface, to melt interfacial ice, using coils and a high frequency power supply disposed proximal to the scraper.

### CROSS REFERENCE TO RELATED APPLICATION

The present patent application claims priority, under 35 U.S.C. §119(e), from the commonly assigned co-pending U.S. Provisional Patent Application Ser. No. 61/267,406, entitled “MECHANICAL SCRAPER SYSTEM WITH SYNCHRONIZED PULSE ELECTROTHERMAL DEICING”, filed Dec. 7, 2009.

### FIELD OF THE INVENTION

The present invention relates generally to ice removal, and in particular to systems and methods for removing ice through mechanical and Pulse Electrothermal Deicing (PETD).

### BACKGROUND

Ice presents many problems to a variety of industries, including transportation industries such as aviation and ground transportation. For example, ice formed upon airport runways, parking lots, bridges, overhead cables for aerial trams, highways and train tracks or rails can create a hazardous environment for drivers and passengers of aircraft or vehicles, as well as any proximate pedestrians. Ice formed upon a surface of a transportation vehicle, such as a windshield, may create additional hazards conditions. For example, if ice formed upon a vehicle windshield it may impair the vehicle operator's vision to the point that the operator will no longer be able to properly navigate the vehicle. Removing the ice from such structures or surfaces can minimize hazardous conditions.

Deicing is a process in which interfacial ice attached to a structure or surface is either melted or broken loose from the structure. Systems for melting ice include electric heaters that apply power to resistive elements to generate heat, and chemicals that depress ice melting point, thus forcing the ice to melt. Electric heaters apply a magnitude of power to a resistive element to directly and proportionally melt all ice from the surface in contact with the electric heaters. These heaters may melt all of the ice from the surface of direct contact; however, this is accomplished at considerable electrical expense. Chemical solutions may dissolve all proximate ice, but do not last for extended periods of time and may contaminate the natural environment. These systems are inefficient since they seek to completely melt all of the ice.

Present methods for breaking ice from a structure include using a mechanical scrapper. Mechanical scrapers are frequently used to dislodge ice bound to an object's surface. Although scrapers may provide a solution to the electrical and environmental costs of electrical and chemical ice removal, they are often hand-held and frequently unwieldy to operate. Furthermore, mechanical scrapers are not always effective in removing ice and may damage surfaces to which ice is bound.

Over the years, a number of attempts have been made to address the above-described challenges in the implementation of mechanical ice-removal, but none have achieved any measurable commercial success, and each suffered from significant disadvantages and drawbacks.

For example, U.S. Pat. No. 3,964,183, entitled “METHOD AND APPARATUS FOR DETACHING COATINGS FROZEN ON TO SURFACES”, issued on Jun. 22, 1976, teaches an apparatus and method of freeing a coating of ice, snow or frost frozen on to the surface of a manufactured material (e.g. a man-made structure such as a building, a road, etc., by concentrating an intense beam of visible light on to the interface between the ice coating and the surface adequate to raise the temperature at the interfacial zone to the melting point and thereafter utilizing a structure for immediately breaking and removing the ice coating. This approach is quite inefficient and slow because as taught by the '183 patent, radiant light-based heating is applied indirectly to the surface being de-iced separately from application of a conventional mechanical structure for breaking/removing ice and thus requires a very significant amount of energy and a great deal of time to disrupt the target interfacial layer. Furthermore, the effectiveness of the radiant heating technique is significantly dependent on reflectivity and other light absorption/reflection/refraction properties of the surface being deiced.

In another example, U.S. Pat. No. 4,571,860, entitled “METHOD AND APPARATUS FOR REMOVING ICE FROM PAVED SURFACES”, issued on Feb. 25, 1986, teaches a vary narrowly focused apparatus and method specifically configured for removing ice and snow from pavement having a carbonaceous top surface, by passing a very high frequency (i.e., 915 M-Hz) micro-wave generator with wave guide over the ice to be melted, followed closely by a scraper, such that ostensibly the radiating high frequency micro-waves pass through the ice, while the carbonaceous top surface of the pavement absorbs the micro-waves and becomes heated thereby, melting the interfacial layer of the ice, thus allowing the ice to be scraped off without damaging the pavement. At the outset, it is clear that the approach taught by the '860 patent suffers from the same disadvantages as are discussed above, in connection with the '183 patent. However, the '860 patent's techniques have significant additional disadvantages and limitations that make commercial implementation thereof highly unpractical. First, the '860 patent's techniques are limited for use only on pavements, and not on any other structures due to the dangers posed by its utilization of high frequency radiating microwaves. Second, event with respect to pavements, the '860 patent techniques only work when the pavement to be deiced comprises a (1) reflective, (2) heat-insulating and (3) carbonaceous composition or top-coat, specifically noting that any pavement without all three of these properties will require a special top-coating before utilization of its proposed solution. Moreover, the dangers posed by a vehicle equipped with such a powerful radiating microwave generator and wave guide cannot be ignored (for example, the risk of radiating microwaves being directed towards living beings or other vulnerable targets if the vehicle equipped with the generator overturns or otherwise becomes unbalanced.

Clearly, the above-described previously known attempts to supplement mechanical ice removal with radiating energy techniques are quite flawed and are not candidates for practical implementation.

However, the aforementioned drawbacks and limitations of directed radiant energy ice-melting approaches are not shared by a powerful deicing technique that may be advantageously utilized in the process of breaking ice from a surface—PETD (Pulse Electrothermal Deicing)—such as described in commonly owned, U.S. Pat. No. 6,870,139, filed 11 Feb. 2003, which is hereby expressly incorporated herein by reference.

Briefly, PETD provides ice removal, for example, by thermally modifying interfacial ice at the interface between an object and ice (also referred to herein as “ice-object interface”). Heating energy may be applied to the interface to melt an interfacial layer of ice; such application may be limited in duration so that heating energy applied to the interface has a heat diffusion distance within the ice that extends no more than through the thickness of either the ice, or the corresponding substrate.

However, while PETD provides efficacious, energy-saving disruption of the ice-object bond, removal of dislodged ice must still be accomplished. This is often achieved by simple gravity; however, gravity does not always provide a desired solution. And whereas, there exist certain advantageous techniques that may be readily used in conjunction with application of PETD to assist in removal of dislodged ice (such as taught in the commonly assigned co-pending U.S. Provisional Patent Application, entitled “System And Method For Icemaker And Aircraft Wing With Combined Electromagnetic And Resistive Pulse Deicing”, Ser. No. 61/152,621, filed Feb. 13, 2009, which, inter alia, teaches synchronization between utilization of PETD and application of an electromagnetic pulse to remove ice, such techniques are of limited use in many ice/snow removal applications in which physical removal of dislodged ice is the only practical option.

### SUMMARY

In one exemplary embodiment of the present invention, a mechanical scraper (such as a plow, brush, shovel, blade, scraper, windshield wiper or other mechanical ice removal apparatus) is combined with PETD for deicing. The scraper is synchronized with energy pulses such that each region of the surface receives a pulse just prior to application of the scraper. Such a combination lowers both electrical and mechanical energy requirements associated with ice removal. Less electrical energy is required, since only a thin interfacial layer of ice is heated and melted. Less mechanical power (for example, push- or pull-power) is required to remove the ice from a pulsed surface than from a surface that has not received a pulse, since the pulse disrupts adhesion of ice to the surface. The mechanical scraper combined with PETD may be effectively used to remove ice from an upward-facing horizontal surface.

In another exemplary embodiment of the present invention, the PETD system is contained with the object to be deiced, at or near the surface upon which ice is adhered (i.e., the “target surface”). The PETD system may include a heating element, such as a metal, or another an electrically conductive material. A pulse of power is applied to the ice-object interface of the object to be de-iced, via the heating element. The pulse disrupts the ice-object interface, (i.e., by melting an interfacial layer of ice) thus facilitating removal by a mechanical scraper as it moves over the surface. The target surface may be configured in a variety of different ways, for example, the surface may comprise one or more of the following: a thin conductive layer such as a metal sheet, metal foil, conductive composite materials such as conductive asphalt, conductive concrete, conductive polymer composite, and/or conductive paint. Such electrically conductive composite materials can contain metallic powder, metal wires, graphite fibers, carbon black, and/or carbon nano-tubes. Surfaces that are already conductive—such as metal bridge decks, car hoods and roofs, metal roofs, railroad rails and railroad aerial conductors, conductors of tram and trolley bus lines, power rails and caternary power cables—may require little or no modification.

In yet another exemplary embodiment of the present invention, the heating element may be configured as a part of a novel scraper assembly that incorporates a PETD system (e.g., the heating element may be within, or incorporated into, one or more predetermined ice/snow contact or “primary” surfaces of the scraper). The novel scraper also includes a secondary surface, connected to the primary surface, configured for removal (or repositioning, etc.) of the ice/snow dislodged by the primary surface.

Preferably, the ice contact scraper surface is configured such that it is the region of the overall scraper assembly that initially contacts with the ice to be scraped. For example, in a “pushing” forward-mounted scraper configuration, the ice contact scraper surface would be positioned in the furthest front and bottom-most region of the scraper assembly, in a “pulling”/“dragging” rear-mounted scraper configuration, the ice contact scraper surface would be positioned in the furthest back and bottom-most region of the scraper assembly, in a “wiper blade” scraper configuration, the ice contact scraper surface would be positioned along the longitudinal edge of the wiper blade, while in a “brush” scraper configuration, the ice contact scraper surface would comprise a plurality of scraper brush bristles.

During operation of the inventive scraper, a pulse of power is applied to the ice-object interface via the primary surface of the scraper. The pulse interrupts the ice-object interface, thus facilitating ice removal by the secondary surface of the scraper as it moves over the iced object. In one alternate inventive embodiment, the primary and secondary surfaces are configured as the same surface, such that the novel scraper may move uninterruptedly over the object as the pulse is applied. In another examplary alternate embodiment, the two surfaces are different; and there may be a pause (i.e., the scraper may pause) between application of the pulse by the primary surface and removal of the ice by the secondary surface. It is further possible to integrate these two surfaces with a mechanical apparatus for removing snow to precede the deicing, and/or with an airflow system for drying the surface after it is deiced.

The primary surface may also be heated by electromagnetic induction of current within the surface. In one embodiment of the present invention, the scraper includes a power source and copper coils, which cooperate to induce an electromagnetic current in the surface of the object (conductive or coated with conductive layer) to be deiced. The conductivity of the object permits electromagnetic induction of current therein. The current produces heat energy at the primary surface, thus melting an interfacial layer of ice at the ice-object interface.

The induction heating system may also be incorporated with a mechanical scraper. For example, in a further embodiment of the present invention, a mechanical scraper is configured to include an electrically conductive scraping surface. Current induced in the scraping surface is then converted to heat, and melts the interfacial layer of ice at the ice-object interface. Following melting, the scraper is run over the surface of the object to remove the ice.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### BRIEF DESCRIPTION OF THE DRAWINGS

In the drawings, wherein like reference characters denote corresponding or similar elements throughout the various figures:

FIG. 1 is a flow chart illustrating one exemplary process embodiment for performing synchronized pulse electrothermal deicing (PETD) with a mechanical scraper;

FIG. 2 shows one exemplary embodiment of synchronized PETD with a mechanical scraper;

FIGS. 3A and 3B depict a further exemplary embodiment of synchronized PETD with a mechanical scraper;

FIGS. 4A and 4B show an exemplary embodiment of synchronized PETD with a mechanical scraper for use on a surface with a conductive substrate;

FIG. 5 depicts an exemplary embodiment of synchronized PETD with a mechanical scraper, including an additional snow removing device and a drier; and

FIG. 6 depicts an exemplary alternate embodiment of the inventive system of FIG. 3A-FIG. 5

### DETAILED DESCRIPTION

Before proceeding with the detailed description, it is to be appreciated that the present teaching is by way of example, not limitation. The concepts herein are not limited to use or application with a specific type of mechanical scraper with synchronized pulse electrothermal deicing. Thus, although the instrumentalities described herein are for the convenience of explanation, shown and described with respect to exemplary embodiments, it will be appreciated that the principals herein may be equally applied in other embodiments of mechanical scrapers with PETD. It should also be noted that various embodiments of the present invention may be readily utilized in conjunction with removal of ice/snow from a wide variety of surfaces/objects, including, but not limited to: aircraft structures and components thereof, vehicles (and components thereof, such as windshields, windows, headlights, mirrors, sun- and moon-roofs, etc.), mirrors, light fixtures and structures for mounting thereof, generally flat open surfaces (e.g., patios, decks, parking lots, etc.), bridges, roads (and equivalent surfaces—e.g., runways, highways, driveways, sidewalks, etc.), building structures and components thereof (roof, stairs, windows, skylights, etc.), overhead cables of trams, trolley buses, and trains, train and tram tracks or rails, as well as decks, rigs, walkways, and other structures of ships, boats and of other marine vehicles and platforms.

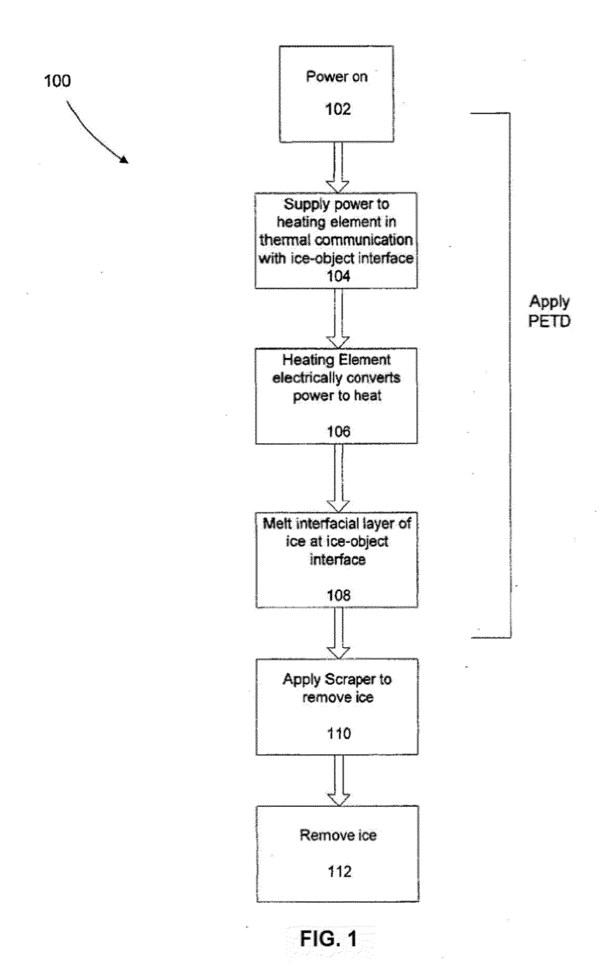

FIG. 1 illustrates a flow chart of an exemplary process 100 for performing mechanical scraping with PETD. In this exemplary process, after powering on, block 102, power is supplied to a heating element in thermal communication with an ice-object interface, block 104. The power source may be a battery, an electrical outlet or other recognized power source. The heating element converts power to heat, block 106. In one example, block 106, the heating element converts power to heat by electrical resistance. In block 108, the heat melts an interfacial layer of ice at the ice-object interface, thus facilitating removal of the ice with a scraper, blocks 110-112. The interfacial layer is usually between about one micron and one millimeter thick; however, the interfacial layer may also be thicker, for example, about 1 centimeter thick.

Advantageously, the synchronization of application of PETD during utilization of the mechanical scraper overcomes a significant challenge of the relatively short time-frame in which the ice-object interface will re-freeze (a time-frame which grows shorter at lower ambient temperatures and in view of other relevant factors), because the scraper is configured to remove the dislodged ice/snow from the target surface almost immediately after the dislodgement thereof, thereby virtually eliminating the risk of the ice-object interface re-freezing.

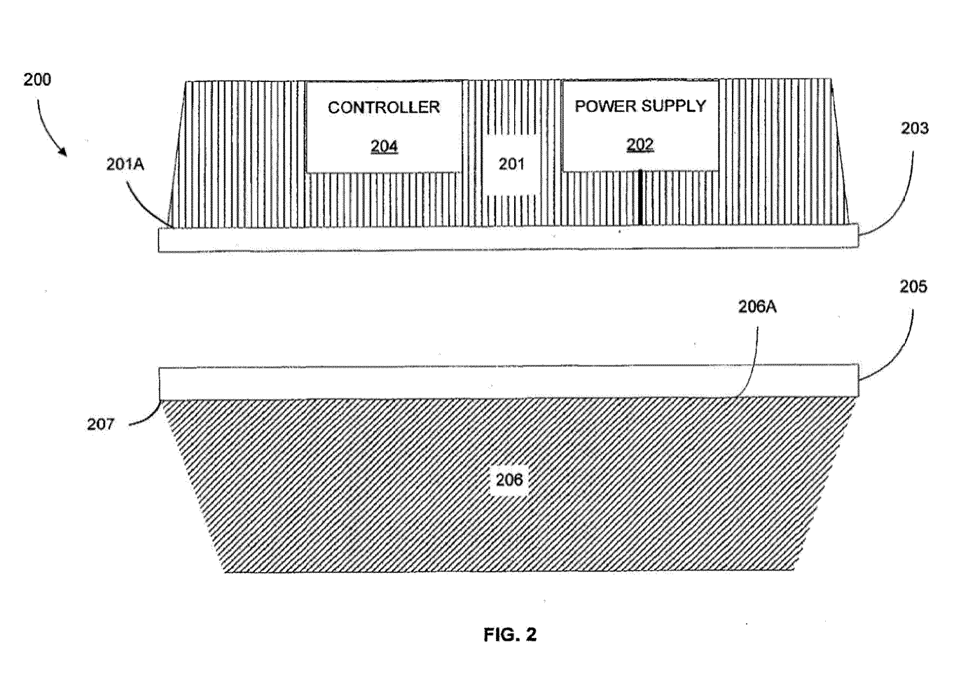

While in most deicing applications PETD is implemented through application of a high power “pulse” to the target region, it should be noted that in accordance with the present invention, and as described in greater detail below in connection with FIGS. 2 to 5, rather that applying a single “pulse” to the entire ice-object interface, the inventive system applies “high frequency induction” heating power continuously, but only during specific short time periods having durations that approximately equal to the size of the heating element divided by the scraper velocity. Thus, short heating “pulses” are effectively applied to each region of the object/surface being deiced, even though the inventive system' is continuously drawing power during its operation. Among the advantages of the utilization of the novel “pulse induction heating” technique as noted above, and as discussed in greater detail below is the fact that there is no need for costly system components such as bus bars and lids that would otherwise be necessary with previously known solutions.

The processes described in blocks 102-108 represent an exemplary embodiment of PETD in accordance with the present invention. However, PETD may be applied in other applications, as described below.

FIG. 2 shows an exemplary system 200. System 200 includes scraper 201 with power supply 202, controller 204, and heating element 203. Power supply 202 is coupled to heating element 203, disposed within or upon a surface 201A of scraper 201. Power supply 202 supplies pulse heating power to heating element 203 to interrupt (i.e., melt) interfacial ice 207 at the ice-object interface (i.e., the interface between bulk ice 205 and object 206), while scraper 201 is worked over a surface 206A of object 206 to remove the bulk ice 205. It is understood that scraper 201 may pause as energy pulses are delivered at the ice-object interface, or scraper 201 may continually move over the surface 206A of object 206 as pulses are delivered. Because energy pulses are delivered via power supply 202 and through heating element 203 of scraper 201, scraper 201 may concentrate upon one specified area at a time of the surface 206A of object 206. Scraper 201 may, however, be of sufficient size to deice the entire object 206 with one scrape.

Consider scraper 201 as a plow. System 200 is capable of selectively pulsing power to chosen areas of scraper 201. It may be desirable to further conserve electrical energy by pulsing only selected areas of the ice-object interface, thus weakening the overall bond between ice 205 and object 206 by interrupting (i.e., melting) selected areas of interfacial ice 207. Mechanical ice removal by scraper 201 is thus facilitated while electrical energy is conserved.

Power supply 202 may be configured for generating power with a magnitude that is substantially inversely proportional to a magnitude of energy used to melt interfacial ice 207. Heating element 203 is coupled to power supply 202 to convert the power into heat at the ice-object interface. Controller 204 is coupled to the power supply 202 to limit a duration in which heating element 203 converts the power into heat. The duration in which heating element 203 converts the power into heat is, in this example, substantially inversely proportional to a square of the magnitude of the power.

Controller 204, by way of example, controls the time in which power is delivered to heating element 203 according to the following relationship:

$$t = {\frac{{π ( {T}_{m} - T )}^{2}}{4 {W}^{2}} [ \sqrt{{λ}_{i} {ρ}_{i} {c}_{i}} + \sqrt{{λ}_{s} {ρ}_{s} {c}_{s}} ]}^{2} , \qquad ( Eq . 1 \text{-} 1 )$$

where

Tₘ is an ice melting temperature, T is an ambient temperature, λ is a thermal conductivity coefficient, ρ is the material density, and c is the material heat capacity (subscript “i” denotes ice and/or snow and subscript “s” denotes substrate material) and W is a power per square meter.

Controller 204, by way of example, also controls the magnitude of power that is delivered to heating element 203 such that energy Q at the ice-object interface is inversely proportional to the magnitude of power. In one example, controller 204 controls the magnitude of power according the following relationship:

$$Q = W \cdot t = {\frac{{π ( {T}_{m} - T )}^{2}}{4 W} [ \sqrt{{ρ}_{i} {c}_{i} {λ}_{i}} + \sqrt{{ρ}_{s} {c}_{s} {λ}_{s}} ]}^{2} . \qquad ( Eq . 1 \text{-} 2 )$$

Accordingly, to reach a desired temperature (e.g., to melt interfacial ice 207 at the ice-object interface) with less energy, one increases heating power W while applying the heating power over a shorter period of time. The above equations are particularly useful for short power pulses when a heat diffusion length is less than the target object thickness (e.g., the thickness of interfacial ice 207). In some embodiments, a more accurate approximation can be found by adding the energy used to melt a very thin layer of interfacial ice, Qₘᵢₙ:

$${Q}_{min} = {d}_{i} \cdot {q}_{i} \cdot {ρ}_{i} \approx 4 \cdot {10}^{3} \frac{Joule}{{m}^{2}} , \qquad ( Eq . 1 \text{-} 3 )$$

where
dᵢ is melted layer thickness, ρᵢ is ice density, and qᵢ is ice latent heat of fusion. Accordingly, in one example, controller 14 controls the magnitude of power according the following relationship:

$$Q = {\frac{{π ( {T}_{m} - T )}^{2}}{4 W} [ \sqrt{{ρ}_{i} {c}_{i} {λ}_{i}} + \sqrt{{ρ}_{s} {c}_{s} {λ}_{s}} ]}^{2} + {d}_{i} \cdot {q}_{i} \cdot {ρ}_{i} . \qquad ( Eq . 1 \text{-} 4 )$$

In should be noted that eq. 1-1 to eq. 1-4 are applicable only when heat-penetration length is less than thickness of the ice and the substrate (i.e., when the system is in the PETD mode).

In illustrative operation, system 200 may for example be used with an automobile to remove ice 205 from a windshield as object 206. In this example, heating element 203 is embedded in scraper 201 (e.g., a windshield wiper) where power supply 202 and controller 204 cooperate to provide power that is sufficient to melt interfacial ice 207 at the ice-object interface in accordance with Eqs. 1-1 and 1-2. It is understood that, in a further embodiment, heating element 203 may be embedded in the windshield. Power supply 202 and controller 204 are thus part of the car's electrical system and in electrical connection with heating element 203 (e.g., power supply 202 is the electrical system of the vehicle, connected with heating element 203 via controller 204), to provide power that is sufficient to melt interfacial ice 207 at the ice-object interface in accordance with Eqs. 1-1 and 1-2.

To further illustrate operation of system 200, consider the properties of ice:

λᵢ=2.2 Wm⁻¹K⁻¹, ρᵢ=920 kgm⁻³, cᵢ=2 kJkg⁻¹K⁻¹, qᵢ=333.5 kJkg⁻¹. (Eq. 1-5)

The properties of a typical windshield (e.g., a substrate) are:

λₛ≈1 Wm⁻¹K⁻¹, ρₛ≈3000 kgm⁻³, cₛ≈1.54 kJkg⁻¹K⁻¹. (Eq. 1-5)

According to Eq. 1-1, the time it takes to reach the ice melting point (0° C.) starting at −10° C. and at a power rate of 100 kW/m² is t≈0.04 second with a glass or glass-like substrate (as object 206). The melting time from Eq. 1-3 may add about 0.04 seconds to the duration. A corresponding total de-icing energy Q at W=100 kW/m² and −10° C. may thus be defined as:

$$Q = 100 kW \text{/} {m}^{2} \cdot 0.04 sec + 4 \cdot {10}^{3} \frac{Joule}{{m}^{2}} = 8 \frac{kJoule}{{m}^{2}} . \qquad ( Eq . 1 \text{-} 7 )$$

At the same temperature of −10° C. and a lower power of W=10 kW/m², however, the energy Q may be defined as:

$$Q = 10 kW \text{/} {m}^{2} \cdot 4 sec + 4 \cdot {10}^{3} \frac{Joule}{{m}^{2}} = 44 k \frac{Joule}{{m}^{2}} . \qquad ( Eq . 1 \text{-} 8 )$$

One advantage of the foregoing example is that it decreases deicing energy, as compared to prior art systems by about one order of magnitude by increasing the power rate by about one order of magnitude while shortening the time of applied power by about two orders of magnitude. By limiting the time power is applied to the ice-object interface, the drain of heat energy into the environment and into bulk ice 205 is limited. Instead, more energy remains conformed to the ice-object interface for melting interfacial ice 207 as a result of shorter power pulses. As shown in the above-incorporated '139 patent, the energy-saving advantage of the PETD method becomes readily apparent when the power density, W, exceeds 1.75 kW/m². Notice that a usual range of power density used in the PETD lays in between 1.75 kW/m² and 1MW/m².

In FIG. 2, Controller 204, power supply 202 and heating element 203 are, for example, shown disposed within or upon scraper 201. It is to be understood and appreciated that controller 204, power supply 202 and heating element 203 may likewise be disposed upon or within the object to be deiced, such as described above.

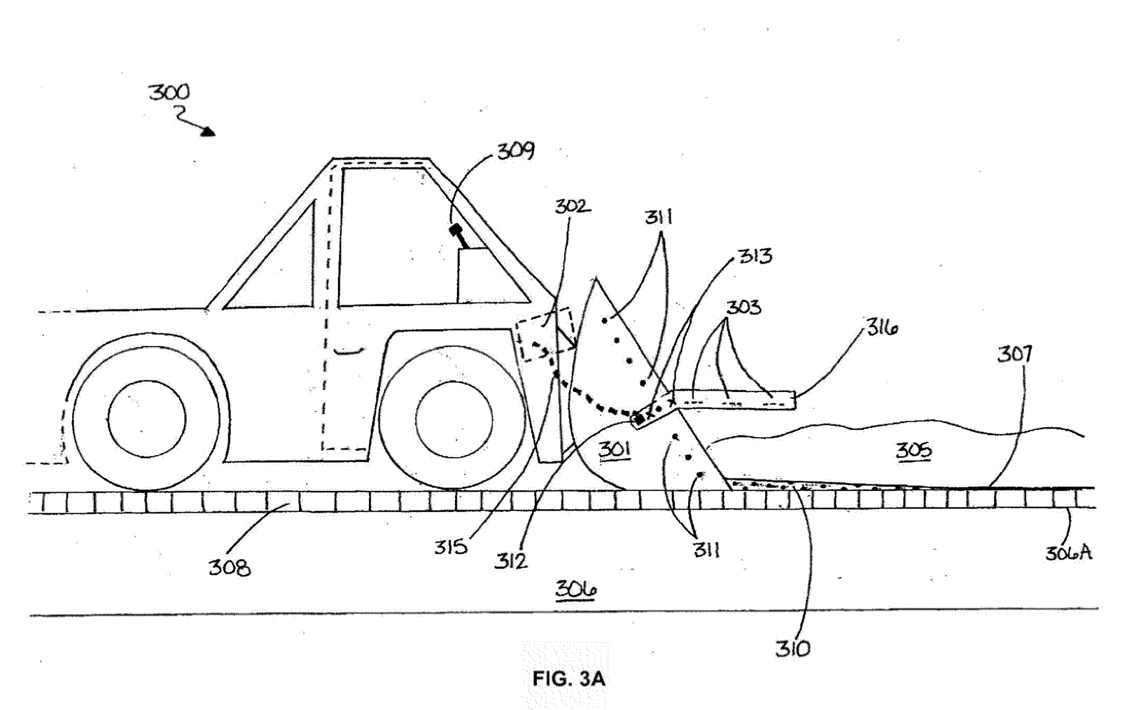

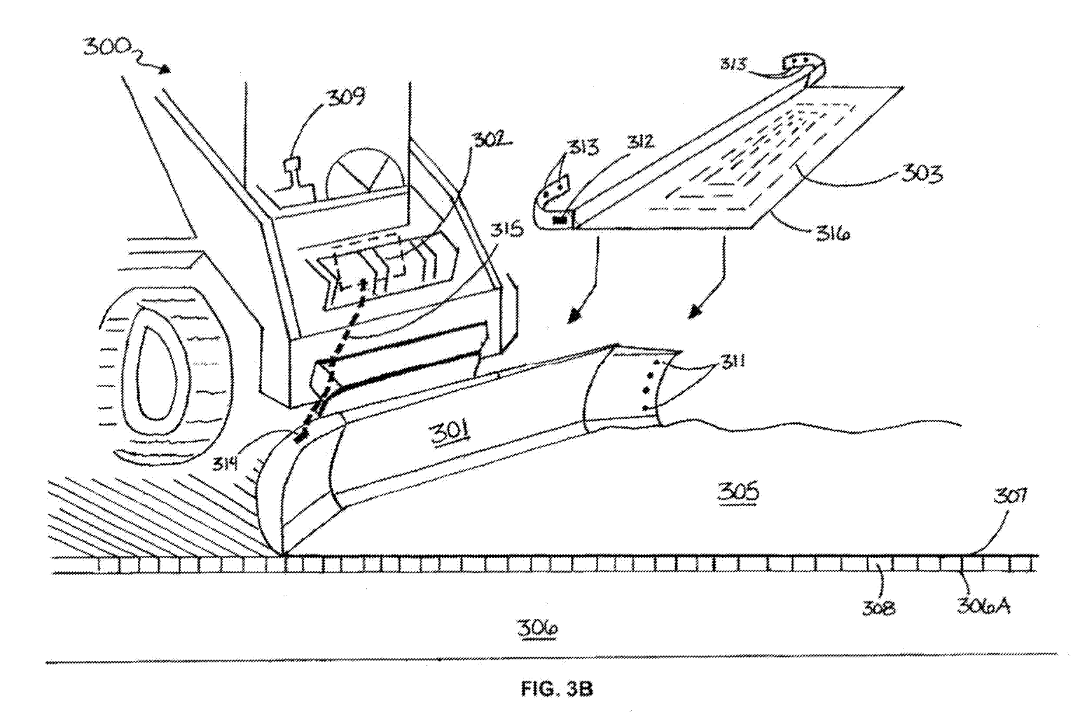

In the embodiment of FIGS. 3A and 3B, a high-frequency (HF) power supply 302, for example, a 50 kHz power supply, is electrically connected to coils 303 (e.g., copper spirals). Power supply 302 and coils 303 are hereinafter referred to as induction heating apparatus 304. Power supply 302 pulses energy to coils 303, which in turn electromagnetically communicate with conductive layer 308, disposed on a surface 306A of object 306 to electromagnetically induce current within the surface 306A of object 306. In the embodiment of FIG. 3, object 306 is a substrate such as asphalt or glass, and surface 306A of object 306 includes or is coated with a conductive layer 308. Induction of electromagnetic current in the surface of object 306 disrupts an interfacial layer of ice 307 at the ice-object interface (i.e., the interface between conductive object 406 and ice 305), for example, by melting. As shown, synchronized system 300 includes scraper 301, which connects to or includes induction heating apparatus 304. Subsequent to pulse deicing via interaction of induction heating apparatus 304 with conductive layer 308, scraper 301 runs along surface 306A of object 306, removing ice 305. In at least one exemplary embodiment of the present invention, the frequency of the HF-power supply may be selected to be in a typical range of frequency used in induction heating (e.g., between 1 kHz and 1 MHz). In accordance with another advantage of the utilization of the novel “pulse induction heating” technique, for embodiments of the present invention in which conductive material sheets are utilized, a greater degree of overall system efficiency may be readily achieved by appropriately increasing (or otherwise modifying) the resistance thereof by adjusting the frequency of the alternating current delivered thereto (as a result of the “skin-effect”). This technique is particularly effective when the conductive sheets comprise ferro-magnetic materials, such as steel.

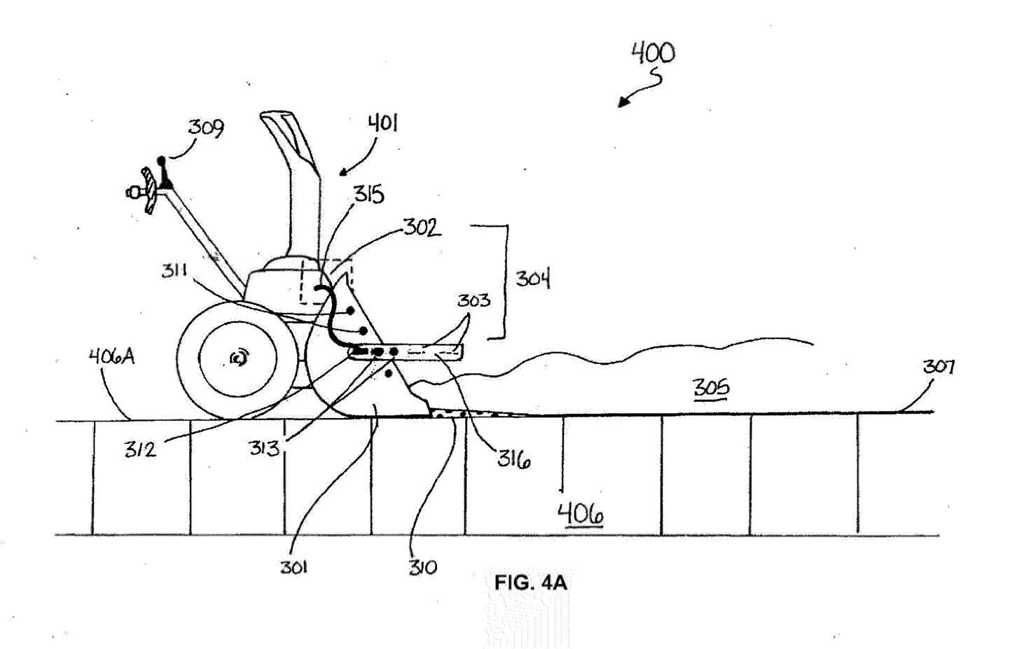

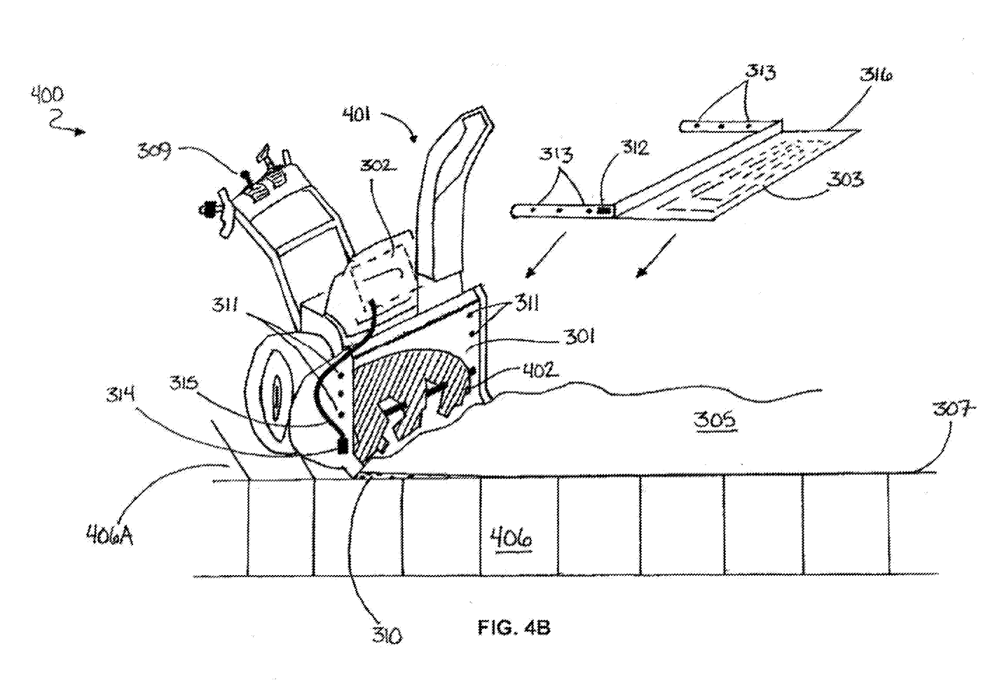

FIGS. 4A and 4B depict an embodiment of synchronized PETD with a mechanical scraper as synchronized system 400, where the object to be deiced is a conductive object 406. In such case, the need for additional conductive layer 308 (FIG. 3) is eliminated. In synchronized system 400, induction heating apparatus 304 interacts directly with conductive object 406 to induce electromagnetic current and disrupt interfacial ice 307 at the ice-object interface. Scraper 301 then moves over the surface 406A of conductive object 406, removing the ice 305. As shown in FIGS. 3 and 4, a layer of water 310 may result from melting of interfacial ice 307 at the ice-object interface. In a further embodiment, a drier is provided to dry the surface of conductive object 406, thus preventing re-freezing at the surface 406A of conductive object 406 after deicing.

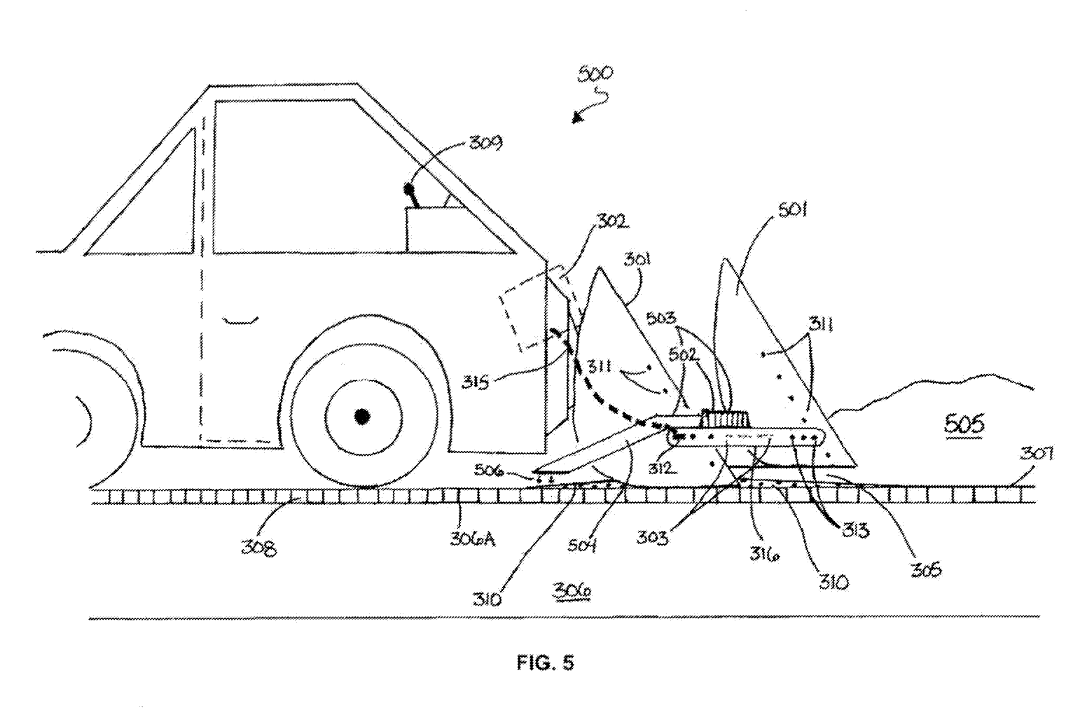

FIG. 5 illustrates an embodiment of synchronized PETD with a mechanical scraper, including both the aforementioned drier and an additional mechanical snow-removal apparatus, configured to remove snow from the surface of an object prior to deicing. Synchronized deicing system 500 includes snow removal apparatus 501, power supply 302, coils 303, fan 502 and duct 504. Fan 502 and duct 504 are collectively referred to as drier 503. Snow and ice removal begins as snow removal apparatus 501 runs over the surface 306A of object 306. As shown in FIG. 5, object 306 includes conductive layer 308 disposed upon surface 306A. It will be understood and appreciated that deicing system 500 may equally be applied to a conductive surface that does not include a separate conductive layer, for example, conductive object 406 (FIG. 4).

Subsequent to removal of snow 505 by snow removal apparatus 501 (which may be, for example, a snow plow, a brush, a shovel, or other apparatus for removing snow), power supply 302 supplies power to coils 303. Collectively, power supply 302 and coils 303 are again referred to as induction system 304. As described herein above, induction system 304 induces current in the surface 306A of object 306, through electromagnetic interaction with conductive layer 308. An interfacial layer of ice, such as interfacial ice 307 at the ice-object interface is thus melted, leaving water 310 on the surface 306A of object 306. Scraper 301 then moves over the surface 306A of object 306, removing the ice 305. Drier 503 then dries the surface 306A of object 306. For example, fan 502 may generate air flow past coils 303, such that coils 303 warm air 506 as it travels to duct 504. Duct 504 then directs warmed air 506 onto the surface 306A of object 306, thus facilitating evaporation of water 310.

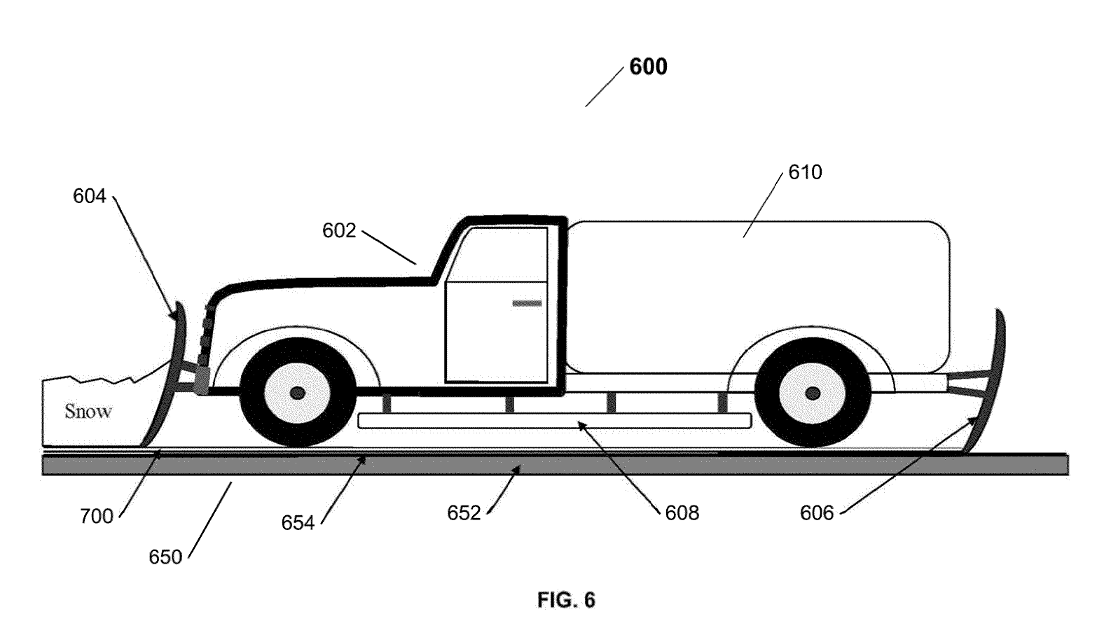

Referring finally to FIG. 6, an exemplary alternate embodiment of the inventive system of FIG. 3A-FIG. 5 is depicted, as a system 600, for removing ice 700 from an object 650 (comprising a road 652 with a conductive layer 654 (as a coating on the road 652, or embedded in the road 652, etc.), that is deployed in a mobile platform 602 (such as vehicle as is shown in FIG. 6 by way of example only). Alternately the mobile platform 602 may be scalably implemented as any human operated (locally or remotely), or computer-operated mobile vehicle/system, as a matter of choice, without departing from the spirit of the invention.

The mobile platform 602 includes a primary scraper 604 (such as a snow plow, etc.), mounted at the front thereof, and positioned and configured toward the operative direction of the system 600 (i.e., forward), such that the primary scraper 604 essentially removes surface snow (and any debris) from the ice 700 as the mobile platform 602 moves forward, and also includes an induction system 608 oriented toward the object 650 (and toward the ice 700 thereon), such as a set of induction coils and/or other novel pulse induction heating elements described above in connection with FIGS. 3A to 5, that is connected to, and powered by, a transportable power source 610 (such as a generator or other high output power supply (e.g., diesel generator, high frequency generator)) also mounted on the mobile platform 602. Preferably, the power source 610 is selected to be of sufficient capacity to output the necessary level of time-power over a region of the ice 700 corresponding with the electrothermal induction pulse heating output area of the induction system 608 (for example only, 10-100 Kw per square meter).

Finally, the mobile platform 602 also includes a secondary scraper 606 (such as an ice scraper, etc.), mounted in the rear region thereof, sequential to the induction system 608, and positioned and configured toward the operative direction of the system 600 (i.e., forward), such that as the mobile platform 602 moves forward, the primary scraper 604 first removes surface snow (and any debris) from the ice 700, the induction system 608 then disrupts an interfacial layer of ice 700 at the ice-object interface (i.e., the interface between conductive object 650 and ice 700), for example, by melting it, thus detaching the ice 700 therefrom, and the secondary scraper 606 thereafter mechanically removes/displaces the detached layer of ice 700 (for example by scooping/breaking up/redirecting, etc.) before the ice 700 can form another bond with the object 650.

Finally, it should be noted that in various above-described embodiments of the present invention, “mechanical” scrapers and equivalent components are shown and described as having structurally rigid “active elements” (e.g., blades or other elements configured for direct contact with the snow/ice being scraped and potentially with the surface of the object(s) being de-iced) by way of example only, and should not limit the configuration and/or the various possible functional elements thereof that may be operable to achieve the desired mechanical scraping functions. For example, a scraper active element may be readily replaced by a directed pressurized fluid (water or other liquid, air, gas, etc.) stream component or equivalent thereof that is operable to provide physical scraping functionality that may be particularly advantageous with relatively fragile and/or irregular target object surfaces, such as aircraft wings/hulls/other components, complex objects such as stairs, light fixtures, etc., as a matter of choice without departing from the spirit of the invention.

Thus, while there have been shown and described and pointed out fundamental novel features of the inventive apparatus as applied to preferred embodiments thereof, it will be understood that various omissions and substitutions and changes in the form and details of the devices and methods illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. It is the intention, therefore, to be limited only as indicated by the scope of the claims appended hereto.

What is claimed is:

1. A mechanical scraper system with synchronized pulse electrothermal deicing, for removing ice and/or snow from at least one target surface of an object, comprising:
a power supply operable to generate electrical power;
a heating element coupled to the power supply, operable to convert the power into heat at an ice-to-object interface, thereby selectively providing electrical heat thereto at a predetermined temperature and for a predetermined duration;
a controller coupled to the power supply, operable to control a magnitude and duration in which power is applied to the heating element to thereby selectively control said predetermined temperature and said predetermined duration; and
a scraper, positioned proximal to said heating element, operable to physically remove ice/snow from a target surface.

2. The system of claim 1, further comprising a snow removal apparatus configured for removing excess snow from the target surface of the object to be deiced.

3. The system of claim 2, wherein said snow removal apparatus is selected from the group consisting of a plow, a brush, a blade, a shovel, a snow blower, a tractor bucket, a windshield scraper, a broom, a pressurized fluid stream, and a windshield wiper.

4. The system of claim 1, further comprising an airflow apparatus configured for drying at least a portion of the target surface after deicing.

5. The system of claim 4, wherein the airflow apparatus comprises a fan and a duct.

6. The system of claim 1, wherein controller is operable to selectively control said magnitude of power applied, such that said power is applied at a magnitude sufficient to only melt an interfacial layer of ice at said ice-to-object interface.

7. The system of claim 1, further comprising a switch coupled to said controller for receiving a control signal from said controller to limit said duration in which said power is applied to said heating element, such that pulses of energy may be applied

8. The system of claim 1, said power supply, heating element and controller being configured with an object that forms said ice-to-object interface, said object being selected from the group consisting essentially of: aircraft structures and components thereof;
vehicles and components thereof, comprising at least: windshields, windows, mirrors, roof glass, and headlights,
light fixtures and structures for mounting thereof,
generally flat open surfaces susceptible to ice and snow accumulation thereon, comprising at least one of: stadiums, rinks, parks, patios, decks, parking lots, roads, paths, runways, highways, driveways, and sidewalks;
bridges and components thereof,
building structures and components thereof, comprising at least: roofs, stairs, windows, and skylights;
overhead cables of electrically-powered vehicles,
train and tram tracks
train and tram rails,
marine vehicle structures and components thereof, comprising at least decks; and
marine platform structures and components thereof, comprising at least decks, rigs, and walkways.

9. The system of claim 1, said heating element comprising conductive material, operable to transfer heat from said heating element to said interface to disrupt an interfacial layer of ice at said interface.

10. The system of claim 1, said controller being configured to be operable to selectively control said magnitude and duration of power applied to various sectors of said heating element.

11. A mechanical scraper system with synchronized pulse electrothermal deicing, comprising:
a high frequency power supply; and
at least one electrically conductive coil coupled to said power supply, for electromagnetically inducing current in a conductive material of an object, to heat an interfacial layer of ice on the object.

12. The system of claim 11, said conductive material being selected from the group consisting essentially of: a coating applied to the object, a metal, a conductive paint, a conductive composite material, a conductive asphalt, and a conductive concrete.

13. The system of claim 11, wherein said coils are disposed in contact with a scraper.

14. The system of claim 12, said scraper being selected from the group consisting essentially of: a blade, a windshield scraper, a windshield wiper, a brush, a shovel, a snow blower, a tractor bucket, a pressurized fluid stream, and a plow.

15. A method of using a mechanical scraper system with synchronized pulse electrothermal deicing, comprising the steps of:
applying PETD at an ice-object interface to disrupt an interfacial layer of ice at said ice-object interface, by supplying power to a heating element in thermal communication with said ice-object interface, converting the power to heat at said heating element, melting an interfacial layer of ice at said ice-object interface; and
applying a scraper to remove the ice therefrom.

16. The method of claim 15, wherein said step of converting power to heat at said heating element, comprises a step of utilizing electrical resistance at said heating element.

17. The method of claim 15, wherein said step of supplying power to a heating element, comprises a step of applying power to a heating element within the object.

18. The method of claim 15, wherein said step of supplying power to a heating element comprises pulsing power to said heating element.

19. The method of claim 15, said step of melting an interfacial layer of ice at said ice-object interface further comprising melting selected areas of said total interfacial layer of ice at selected areas of said total ice-object interface.

20. A method of removing ice from the surface of an object, comprising the steps of:
electromagnetically inducing current in a conductive material of the object, to generate heat in an interfacial layer of ice between the object and the ice; and
applying a scraper to remove the ice therefrom.

21. The method of claim 20, wherein said step of electromagnetically inducing comprises supplying high frequency power to at least one conductive coil positioned within sufficient proximity to the surface of the object.

22. The method of claim 21, wherein the power supply and the at least one conductive coil are disposed at least proximal to the scraper.

23. The method of claim 20, wherein said step of electromagnetically inducing current, comprises a step of inducing current in a conductive coating applied to the object.

24. The method of claim 20, wherein said conductive material of the object comprises a predetermined resistance value, wherein said step of electromagnetically inducing current, comprises a step of inducing current at a predefined alternating current frequency, further comprising the step of modifying said predetermined resistance value to a different desired resistance value, by making a corresponding adjustment to said predefined alternating current frequency.
